(19) United States
(12) Patent Application Publication
(10) Pub. No.: US 2014/0242563 A1
(43) Pub. Date: Aug. 28, 2014

(54) DRUG, SURGICAL, AND MEDICAL EDUCATION PROCESSES

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/187,277

(22) Filed: Feb. 23, 2014

Related U.S. Application Data
(60) Provisional application No. 61/768,608, filed on Feb. 25, 2013.

(51) Int. Cl. G06F 19/00

(52) U.S. Cl. CPC G06F 19/3456
USPC 434/262

(57) ABSTRACT

A national standardized protocol developed by interfacing the FDA, medical societies, pharmaceutical companies, surgical companies, and patient focus groups for education patients about medications and surgical procedures which can be modified as new risks are discovered is desirable. Linking patient metadata to received information and then being able to identify patients about new risks and communicate to each patient is also desirable. Patients should receive all currently available information about a medication or surgical procedure and receive any newly discovered information.

### CROSS-REFERENCES TO RELATED APPLICATIONS

This application claims the benefit of U.S. Provisional Patent Application No. 61/768,608, filed Feb. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

Currently, there is no national standardized physician process to educate patients regarding their medications or procedural risks. Additionally, there is no mechanism to interface with the Food and Drug Administration (FDA), medical societies, surgical companies, pharmaceutical companies and patient focus groups (referred to as collaborating parties) to develop national standardized physician protocols to disseminate future warnings, no mechanism for these groups to collaborate on compiling warnings (consensus warnings), no mechanism to identify which patients should receive warnings, and there is no mechanism to assure that transmitted information reaches patients. Physicians do not have standardized process to deliver protocols for prescribing medications or procedures, they do not have a means of monitoring patients while under treatment, and no mechanism to interface with new consensus warnings to contact patients about risks discovered in the future about medications patients have taken or surgical procedures patients have undergone.

Currently, a patient is verbally educated by his physician about a medication or procedural risks. The patient may receive a handout regarding the medication or surgery and possibly sign an informed consent. Patients receive informational sheets from the pharmacy about prescriptions which are rarely read, and if read at all, are poorly understood. As new information is learned about medications or surgical procedures from the FDA, medical societies, surgical companies, pharmaceutical companies, or patient focus groups (collaborating parties), there is no known process to develop new physician protocols nor is there a process to accurately record what information a patient has received in the past so that a patient can be identified to receive new consensus warnings in the future. Currently, the physician dictation is the only documentation of transferred information. The physician dictation only reflects an opinion of what information was presented to a patient and is incomplete with no reproducibility or quality controls. A physician's information exchange is variable limited to oral, written, or video information, none of which is linked to the patient.

### BRIEF SUMMARY OF THE INVENTION

It would be desirable to provide a standardized physician process developed in collaboration with the FDA, medical societies, surgical companies, pharmaceutical companies, and patient focus groups (collaborating parties) for educating patients about prescription medications and procedural risks and develop a post event monitoring and communication system. Preferred embodiments establish a unique process where patients, physicians, the FDA, medical societies, surgical companies, pharmaceutical companies, and patient focus groups (collaborating parties) are able to nationally standardize communication with patients about their medication and surgical procedures. The system includes vehicles to interface the collaborating parties and develop protocols to communicate future consensus changes in recommendations to health systems or physicians to standardize a process to deliver the standardized protocols, and to automate quality control on protocol lab work, patient visits, and patient education.

In an exemplary embodiment, a method of educating patients about medication and surgical procedures includes the steps of (a) displaying an educational video to a patient about a medication or surgical procedure; (b) recording the patient watching the educational video, and storing the recording on a system server; (c) displaying an informed consent on a display screen, and enabling the patient to sign the informed consent on the display screen; (d) presenting test questions on the display screen about the educational video, and enabling the patient to answer the test questions; (e) recording a physician consult with the patient, and storing the recording on the system server; and (f) linking patient identification metadata to the educational video, the recordings and printed materials relating to the medication or surgical procedure. A software platform software platform enables collaboration between the FDA, medical societies, surgical companies, pharmaceutical companies, and patient focus groups (collaborating parties) to develop consensus protocols.

The method may further include providing the patient with a link to access the educational video, the recordings and the printed material via the patient identification metadata. If updated information about the medication or surgical procedure is available, the patient is informed, possibly by e-mail.

A lab flow sheet may be generated with monitoring guidelines and pre-written lab prescription orders for a physician. An alert may be generated when the patient is not compliant with the guidelines.

Other exemplary embodiments include a computer program executable by a computer processor for educating patients, and a system for educating patients.

Still other exemplary embodiments relate to a communication software program to develop consensus warnings through collaboration with the FDA, medical societies, surgical companies, pharmaceutical companies, and patient focus groups (collaborating parties); a software program to integrate consensus warnings into a new national standard physician process; a software program to integrate consensus warnings into physician or healthcare systems computers identifying patients not documented as having experienced the most recent national standard physician protocol about a drug or surgical procedure; and a software program to monitor patient compliance in completing viewing the most recent consensus warning through the most recent national standard physician protocol.

### BRIEF DESCRIPTION OF THE DRAWINGS

These and other aspects and advantages will be described in detail with reference to the accompanying drawings, in which:

FIG. 1 is a flow diagram showing the process, development of national protocols for educating patients about medication and surgical procedures for communicating future consensus warnings; and

FIG. 2 is a detailed schematic illustration of a computer system.

### DETAILED DESCRIPTION OF THE INVENTION

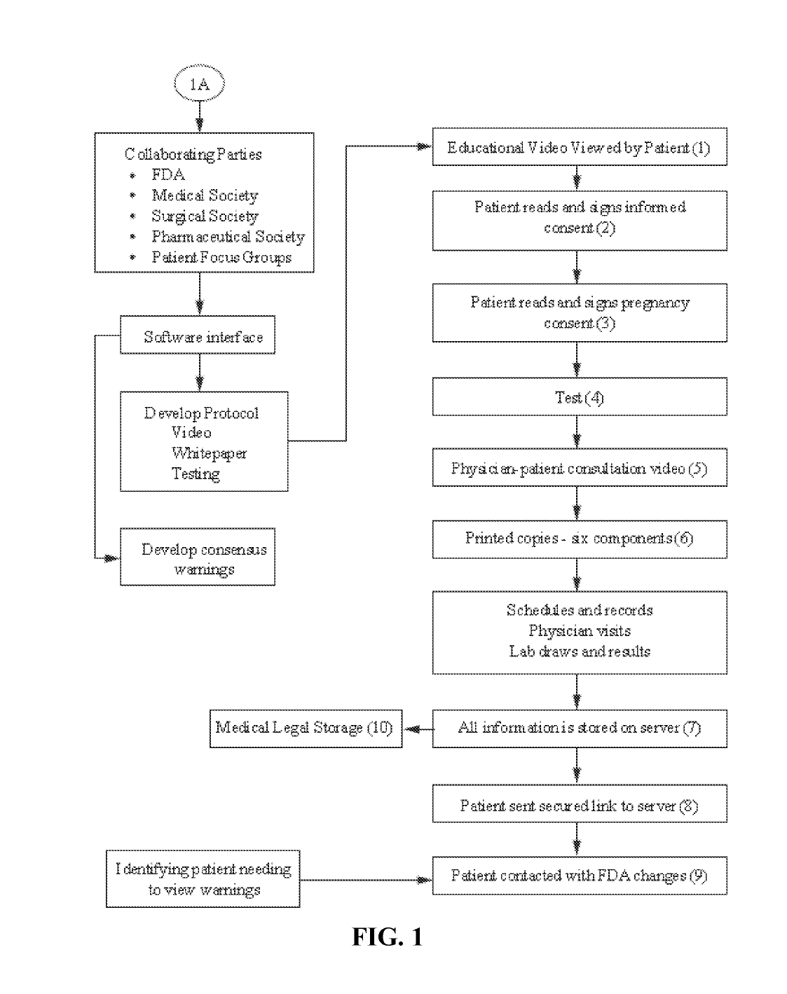

With reference to FIG. 1, collaborating parties use a software interface to develop standardized national protocols with video, white paper, testing, monitoring interface, patients receiving a medication experience a standardized sequence of events. Initially, they are shown a video and white papers prepared by the FDA, medical societies, surgical companies, and pharmaceutical companies, and patient focus groups (collaborating parties) (1A) which discuss in layman's terms the indications, dosing forms, monitoring guidelines, cautions, drug interactions, adverse side effects, use in pregnancy, use in lactation, and use in children (white paper content). The patients are recorded watching the video, and the video is stored in a system server. Patients then read an informed consent about the medicine and pregnancy (if appropriate), and sign a consent on the display (2/3). The patients then take a short test demonstrating their understanding of the material (4).

A video recording is then made of the physician and patient consultation, discussing the risks and side effects and highlighting items that may need emphasis (5). The physician consultation is also stored on the system server. Printed material is given to the patient (6). The printed material (white paper content) may include, without limitation, a transcript of the educational video, a copy of the signed informed consent, a copy of the pregnancy informed consent (if applicable), summary information about the medication, immunization recommendations, lab and follow up protocols, and monitoring guidelines with a patient lab organizer (allowing them to know what laboratory values will be checked and how often those laboratory values will be checked). The patients' lab organizer enables patients to record laboratory results and use apps for labs to interface with their EHR, physicians, and personal data silos on a secured web server. The provider or physician is given a lab flow sheet with monitoring guidelines with pre-written lab prescription orders. All information is sent to a secured web server (7) for patient access to the initial video, the physician-patient consultation, all paper documents, and lab results (8). The patient's identification metadata is linked to the information, and the patients are provided with an internet link to access all information on the server.

Prospectively after a drug is administered, the collaborating parties have a collaborative software platform to develop a consensus warning with new risk resulting productions of a national protocol with new video and white paper content. All patients who have seen an outdated national protocol are contacted (e.g., through their e-mail or cell phone) with instructions to view the new information (9). The process identifies what information is new for each patient based on prior viewed videos and white paper handouts linked to their metadata.

With all medications and surgical procedures, over time new side effects of medications or risks of surgical techniques or problems with surgical hardware are discovered. An example is a medication that may be found, after approved, to cause birth defects, or a surgical procedure such as an artificial hip which may fail early, after being installed. With new FDA, medical society, pharmaceutical company, surgical company, and patient focus group consensus warnings, each individual patient will be identified and be delivered the new information they have not heard. No patient will experience a television or newspaper article alerting him or her about risks of medicines or surgeries they have had in the past. The educational protocol following this specific sequence is repeatable and has scientific validity to enhance patient retention of information. The Quality Assurance Mechanism documenting patient understanding through quizzes and a feedback mechanism enhances information delivery through monitoring patient's responses to the questions. Also, the Quality Assurance Mechanism schedules physician visits and lab draws with results, and monitors patient compliance.

Through an integrated system following laboratory protocols and patient schedules with laboratory values and schedules, patients who are not compliant with the guidelines are contacted. This information for the lab orders and recommended follow up are sent to an Electronic Health Record (EHR) and to the patient's scheduler.

Protocols requiring labs for medication or surgery are integrated with patient schedule apps keeping patients compliant having blood drawn and reports sent to physicians, EHR, and patient apps. Patients who are not compliant with the guidelines are contacted. Copies of all documents, videos and a copy of the patient viewing the drug informational video, white papers, consent, video dates, and lab results are sent to the system server for medical legal reasons (10). All information sent to the server is linked by the patient identification metadata (e.g., “My Records For Life”) and are stored for the patient with unlimited and lifetime access.

The medical education process described with reference to FIG. 1 is preferably a browser-based system in which a program running on a user's computer (the user's web browser) requests information from a server program running on a system server. The system server sends the requested data back to the browser program, and the browser program then interprets and displays the data on the user's computer screen. The process is as follows:
1. The user runs a web browser program on his/her computer.
2. The user connects to the server computer (e.g., via the Internet). Connection to the server computer may be conditioned upon the correct entry of a password as is well known.
3. The user requests a page from the server computer. The user's browser sends a message to the server computer that includes the following:
   the transfer protocol (e.g., http://); and
   the address, or Uniform Resource Locator (URL).
4. The server computer receives the user's request and retrieves the requested page, which is composed, for example, in HTML (Hypertext Markup Language).
5. The server then transmits the requested page to the user's computer.
6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

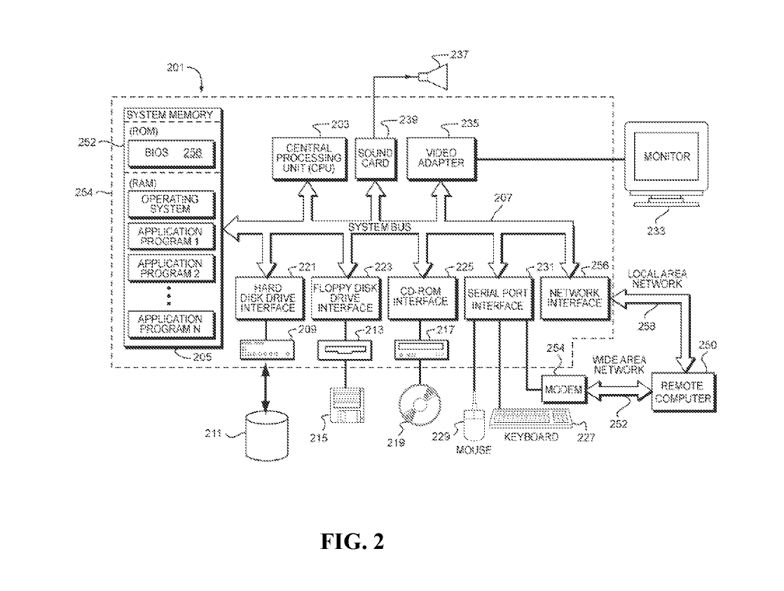

FIG. 2 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of educating patients about medication and surgical procedures, the method comprising:
(a) displaying an educational video to a patient about a medication or surgical procedure;
(b) recording the patient watching the educational video, and storing the recording on a system server;
(c) displaying an informed consent on a display screen, and enabling the patient to sign the informed consent on the display screen;
(d) presenting test questions on the display screen about the educational video, and enabling the patient to answer the test questions;
(e) recording a physician consult with the patient, and storing the recording on the system server; and
(f) linking patient identification metadata to the educational video, the recordings and printed materials relating to the medication or surgical procedure.

2. A method according to claim 1, further comprising providing the patient with a link to access the educational video, the recordings and the printed material via the patient identification metadata.

3. A method according to claim 1, further comprising determining whether updated information about the medication or surgical procedure is available, and when the updated information is available, informing the patient.

4. A method according to claim 3, wherein the step of informing the patient is practiced by sending an e-mail to the patient.

5. A method according to claim 1, further comprising generating a lab flow sheet with monitoring guidelines and pre-written lab prescription orders for a physician with direct communication to the lab.

6. A method according to claim 5, further comprising generating an alert when the patient is not compliant with the guidelines.

7. A computer program embodied on a non-transitory computer readable medium and executable by a computer processor for educating patients about medication and surgical procedures by:
(a) displaying an educational video to a patient about a medication or surgical procedure;
(b) recording the patient watching the educational video, and storing the recording on a system server;
(c) displaying an informed consent on a display screen, and enabling the patient to sign the informed consent on the display screen;
(d) presenting test questions on the display screen about the educational video, and enabling the patient to answer the test questions;
(e) recording a physician consult with the patient, and storing the recording on the system server; and
(f) linking patient identification metadata to the educational video, the recordings and printed materials relating to the medication or surgical procedure.

8. A computer program according to claim 7, further comprising providing an interface between the FDA, medical societies, pharmaceutical companies, surgical companies, and patient focus groups updating current medical standards/information about medications and surgical procedures

9. A computer program according to claim 7, further comprising providing the patient with a link to access the educational video, the recordings and the printed material via the patient identification metadata.

10. A computer program according to claim 7, further comprising determining whether updated information about the medication or surgical procedure is available, and when the updated information is available, informing the patient.

11. A computer program according to claim 10, wherein the step of informing the patient is practiced by sending an e-mail to the patient.

12. A computer program according to claim 10, further comprising documenting new information delivered to patients and confirming patient viewing new video content, signed consent for receiving printed material, and scheduled appropriate follow up.

13. A computer program according to claim 7, further comprising generating a lab flow sheet with monitoring guidelines and pre-written lab prescription orders for a physician.

14. A computer program according to claim 13, further comprising generating an alert when the patient is not compliant with the guidelines.

15. A system for educating patients about medication and surgical procedures, comprising:
at least one user computer running a computer program for educating a patient about medication or a surgical procedure; and
a system server running a server program, the system server and the at least one user computer being interconnected by a computer network,
wherein the system server and the at least one user computer are programmed to:
display an educational video to a patient about a medication or surgical procedure;
record the patient watching the educational video, and store the recording on the system server;
display an informed consent on a display screen, and enable the patient to sign the informed consent on the display screen;
present test questions on the display screen about the educational video, and enable the patient to answer the test questions;
record a physician consult with the patient, and store the recording on the system server; and
link patient identification metadata to the educational video, the recordings and printed materials relating to the medication or surgical procedure.
